(19) United States
(12) Patent Application Publication
(10) Pub. No.: US 2008/0218807 A1
(43) Pub. Date: Sep. 11, 2008

(54) Multi-function photo center

(75) Inventor: Leonard Albert Parker, Pittsford, NY (US)

Correspondence Address: FAY SHARPE / XEROX - ROCHESTER, 1100 SUPERIOR AVE., SUITE 700, CLEVELAND, OH, 44114, US

(73) Assignee: XEROX CORPORATION.

(21) Appl. No.: 11/715,585

(22) Filed: Mar. 8, 2007

(51) Int. Cl. H04N 1/21

(52) U.S. Cl. 358/302

(57) ABSTRACT

An integrated multi-function digital photo device comprises a display unit, a printing unit, a housing, and a frame. The integrated device provides for the display and printing of digital photos in one device rather than in multiple devices.

### BACKGROUND

Photographs, especially digital photographs, have become ubiquitous. Several functions arise in handling digital photos. A repository is needed to store digital photos and organize them logically, chronologically, or categorically. A filing system is needed to locate desired digital photos, especially considering that a consumer may have several hundred or several thousands of digital photos. A device for viewing the digital photo is needed. Finally, a printer is needed for printing out digital photos which may be placed in a picture frame or given to another person.

These functions do not exist in an integrated fashion and are generally only available on multiple devices. For example, laptops, personal computers, photo printers, and digital photo frames incorporate some of these functions, but not all of them. In addition, such devices are generally not designed to be acceptable as permanent attractive displays in living room settings or as fine furniture accessories for office/lobby/gift shop settings.

### BRIEF DESCRIPTION

The present disclosure, is directed towards integrated apparatuses which allow users to store, display, and locally print digital photos.

These and other embodiments are described in more detail below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a rear view of an embodiment of the integrated multi-function digital photo-device of the present disclosure.

FIG. 2 is a side view of an embodiment of the integrated multi-function digital photo device of the present disclosure.

FIG. 3 is a front view of an embodiment of the integrated multi-function digital photo device of the present disclosure.

FIG. 4 is a schematic diagram of the internal architecture of an embodiment of the integrated multi-function digital photo device of the present disclosure.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

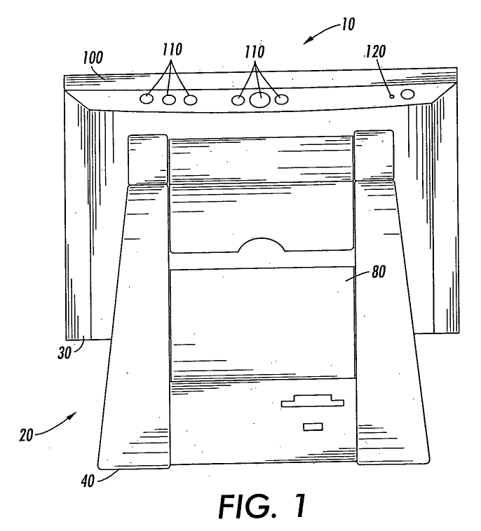

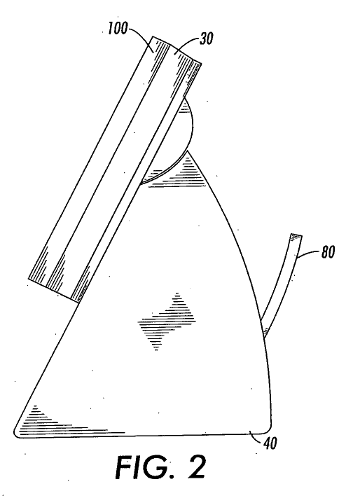

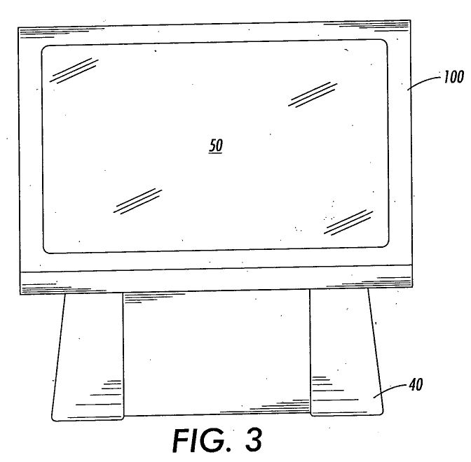

FIGS. 1-3 are various views of an exemplary embodiment of the present disclosure. The multi-function digital photo device 10 has a housing 20. The housing comprises a display housing 30 and a base 40. The display housing 30 and the base 40 may be rotated relative to each other. The display unit 50 is located in the display housing 30. The device 10 may have a storage unit 60 (not shown) for storing the digital photos. The printing unit 70 (not shown) is located in the base 40. As seen here, the base 40 of the housing 20 may further comprise a tray 80; the tray allows paper to be inserted into the housing 20 to be printed upon by the printing unit 70 and supports the paper. Generally, the paper is inserted in the rear of the housing 20 and exits from the front of the housing 20. The base 40 may further comprise a door (not shown) if additional access to the interior of the housing 20 is required. For example, a door may be separate from the tray 80 depending on the configuration of the printing unit 70, in particular the location of any ink supply which may need to be refilled. The device 10 comprises a frame 100 which frames or surrounds the display unit 50. The frame 100 may be integral with the housing 20 or it may be located outside the housing 20. For example, it may be desirable that the frame 100 can be switched or replaced for aesthetic purposes. The device 10 may further comprise various buttons 110 and/or lights 120 to allow the user to interact with the device 10. The device 10 also comprises a processor 130. The processor 130 can control the display unit 50 and generally is connected to all components of the device 10. The processor 130 can control the display unit 50 so that, for example, either a single static photo is displayed or a “slide show” is shown. The processor 130 also allows the display unit 50 to show streaming video and provides image enhancement technology so that the digital photos/video are of a higher quality than without the enhancement.

The multi-function digital photo device 10 may further comprise a storage unit 60 which stores digital photo information. The storage unit can be any device known in the art. For example, the storage unit can be non-volatile memory such as flash memory, EEPROM, or RAM. It is also contemplated that the photo device 10 does not have a storage unit, but that a storage unit containing digital photos is plugged into the photo device 10. For example, the photo device 10 may have a USB port or a card adapter so that storage devices such as a memory stick, an SD card, and the like can be plugged.

The display unit 50 is a flat-panel display and may use any type of display known in the art. For example, the flat-panel display can be liquid crystal display (LCD), plasma, or digital light processing (DLP). The display unit 50 generally has rectangular dimensions. The display unit may have a diagonal length from 4 inches to as large as 50 inches.

The printing unit 70 allows the user to immediately and locally print a digital photo for a person who sees a digital photo and wishes they had a copy. The printing unit 70 may be any unit known in the art. For example, the printing unit can be a liquid inkjet printer, a laser printer, a solid inkjet printer, or a dye-sublimation printer. The printing unit will generally include a print head, an ink supply, a motor, and a belt.

The device 10 may further comprise an interface unit 150. It is contemplated, for example, that the printing unit 70 be used for low volume, high quality, immediate printing, but that high volume printing be fulfilled via web-based print ordering. The interface unit 150 allows the device 10 to communicate with an external source. For example, the interface unit 150 may be a jack, such as a jack for receiving an Ethernet cable, which allows the device 10 to be connected to the Internet. The interface unit 150 may also be a wireless receiver 140 for wireless connection to the Internet or to a computer which contains the storage unit 60. The photo device 10 may, if desired, comprise both a wireless receiver 140 and an interface unit 150 as well.

The housing 20 may, of course, contain any number of slots and/or holes necessary for the various components of the device 10 to operate or communicate with the user. The tray 80 may serve as a temporary tray upon which paper is laid for prints to be made, then be folded up to reduce the footprint of the photo device 10. However, the tray 80 could also serve as a feeder which stores paper. The photo device 10 may receive power either from a battery source or via an AC adapter which is plugged into an electrical outlet. The device 10 may further comprise an audio unit, such as speakers, for providing sound. For example, streaming video may have a soundtrack or narration may be provided for a picture slide show. The audio unit may be located in either the display housing 30 or the base 40 of the housing 20.

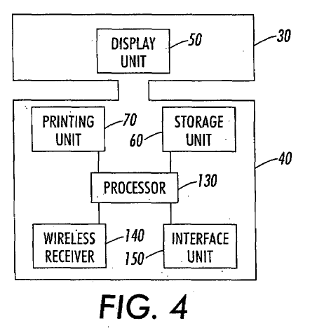

FIG. 4 is a schematic diagram of the internal architecture of one embodiment of the photo device 10. In this embodiment, the display unit 50 is in the display housing 30. The printing unit 70, processor 130, wireless receiver 140, and interface unit 150 are located in the base 40. While the display unit 50 is located in the display housing 30 and the printing unit 70 is located in the base 40, the other components may be located in any part of the housing 20. In this embodiment, the photo device 10 comprises a storage unit 60 which is shown in the housing 20.

The integrated multi-function digital photo device of the present disclosure is very useful. It allows users to electronically transfer or load digital photos, thus serving as a photo repository. It has the capability to sort and store photos in logical and/or chronological folders, thus serving as an electronic filing system for digital photo albums. It can display a single static photo, a slide show of photos, or streaming video. The images may be enhanced. It also allows for integrated low-volume printing or high-volume printing via web-based print ordering.

It will be appreciated that several of the above-disclosed and other features and functions, or alternatives thereof, may be desirably combined into many other different systems or applications. Various presently unforeseen or unanticipated alternatives, modifications, variations or improvements therein may also be subsequently made by those skilled in the art. These combinations and variations are intended to be encompassed by the following claims.

1. An integrated multi-function digital photo device, comprising:
a housing, a frame, a display unit, a processor, and a printing unit;
the display unit, processor, and printing unit being located within the housing; and
the frame framing the display unit.

2. The photo device of claim 1, further comprising a storage unit for storing digital photo information.

3. The photo device of claim 2, wherein the storage unit is non-volatile memory.

4. The photo device of claim 1, further comprising an interface unit for communicating with an external source.

5. The photo device of claim 4, wherein the interface unit is a jack.

6. The photo device of claim 4, wherein the interface unit is a wireless receiver.

7. The photo device of claim 1, further comprising a wireless receiver and an interface unit.

8. The photo device of claim 1, wherein the frame is located outside the housing.

9. The photo device of claim 1, wherein the display unit is a flat panel display.

10. The photo device of claim 1, wherein the housing further comprises a tray which allows paper to be inserted into the printing unit.

11. The photo device of claim 1, having the ability to store digital photos in logical or chronological folders.

12. The photo device of claim 1, having the ability to display a static digital photo, a closed loop slide show, or streaming video.

13. The photo device of claim 1, wherein the housing comprises a display housing and a base, and the display housing is rotatable relative to the base.

14. The photo device of claim 1, further comprising an audio unit for providing sound.

15. An integrated multi-function digital photo device, comprising:
a housing, a frame, a display unit, a processor, and a printing unit;
the display unit being located in a display housing of the housing and framed by the frame;
the processor and printing unit being located within a base of the housing;
the housing further comprising a tray for inserting paper into the printing unit; and
the display housing being rotatable relative to the base.

16. The photo device of claim 15, further comprising a storage unit for storing digital photo information.

17. The photo device of claim 16, wherein the storage unit is non-volatile memory.

18. The photo device of claim 15, further comprising an interface unit for communicating with an external source.
